(19) United States
(12) Patent Application Publication
(10) Pub. No.: US 2008/0068264 A1
(43) Pub. Date: Mar. 20, 2008

(54) RECONFIGURABLE SEARCH ENGINE

(76) Inventor: Nam D. Banh, Aliso Viejo, CA (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 11/766,042

(22) Filed: Jun. 20, 2007

Related U.S. Application Data
(60) Provisional application No. 60/814,998, filed on Jun. 20, 2006.

(51) Int. Cl. G01S 1/00

(52) U.S. Cl. 342/357.15

(57) ABSTRACT

A method and apparatus for reconfiguring a GPS receiver. A device in accordance with the present invention comprises a Radio Frequency (RF) section, the RF section adaptable to receive at least one GPS signal from at least one GPS satellite; and a baseband section, coupled to the RF section, the baseband section comprising at least one correlator, wherein the at least one correlator is adaptable to reacaquire the at least one GPS signal based on a priori knowledge of the at least one GPS signal.

### CROSS-REFERENCE TO RELATED APPLICATIONS

This application claims the benefit under 35 U.S.C Section 119(e) of U.S. Provisional Application Ser. No. 60/814,998, filed on Jun. 20, 2006, by Nam D. Banh, entitled “RECONFIGURABLE SEARCH ENGINE,” attorneys' docket number 201.20-US-P1, which application is incorporated by reference herein.

### BACKGROUND OF THE INVENTION

1. Field of the Invention

The present invention relates generally to Global Positioning System (GPS) receivers, and in particular, to a GPS receiver with a reconfigurable search engine.

2. Description of the Related Art

The use of GPS in consumer products has become commonplace. Hand-held devices used for mountaineering, automobile navigation systems, and GPS for use with cellular telephones are just a few examples of consumer products using GPS technology.

GPS-enabled devices, such as cellular telephones, have also been introduced into the consumer marketplace. These devices allow for the use of Location-Based Services (LBS) which are services, advertisements, and other features that are offered based on the location of the user. As such, GPS-enabled devices are used worldwide.

One of the most pressing problems with GPS devices is that it takes a certain amount of time to initially acquire satellites, and, when the satellite signals are lost, that it is sometimes difficult and time consuming to find the satellite signals again. The search engine of the GPS receiver, typically a correlator, compares a block of known code against the signal and looks for a correlation between the received signal and the known code, and does this search over a given frequency range and a given time. However, little or no intelligence about the prior signals is used to shorten the time to find satellites a second or subsequent time.

It can be seen, then, that there is a need in the art to make GPS-enabled devices that shorten the reacquisition time for satellites in a GPS device-based system.

### SUMMARY OF THE INVENTION

To minimize the limitations in the prior art, and to minimize other limitations that will become apparent upon reading and understanding the present specification, the present invention describes a method and apparatus for reconfiguring a GPS receiver. A device in accordance with the present invention comprises a Radio Frequency (RF) section, the RF section adaptable to receive at least one GPS signal from at least one GPS satellite; and a baseband section, coupled to the RF section, the baseband section comprising at least one correlator, wherein the at least one correlator is adaptable to reacaquire the at least one GPS signal based on a priori knowledge of the at least one GPS signal.

Such a GPS receiver further optionally includes the a priori knowledge of the at least one GPS signal comprising the code phase of the at least one GPS signal, a frequency of the at least one GPS signal, and an amount of time since the GPS receiver lost tracking lock on the at least one GPS signal.

A method in accordance with the present invention comprises acquiring a plurality of GPS signals, determining a frequency and a code phase delay for each signal in the plurality of GPS signals, and reacquiring at least one of the plurality of GPS signals by using the frequency and the code phase delay for the GPS signal to be reacquired to position a correlator. Such a method further optionally includes the GPS receiver having a priori knowledge of the GPS signal to be reacquired, and the a priori knowledge comprises an amount of time since the GPS receiver lost tracking lock on the GPS signal to be reacquired.

### BRIEF DESCRIPTION OF THE DRAWINGS

Referring now to the drawings in which like reference numbers represent corresponding parts throughout:

FIG. 1 illustrates a typical Satellite Positioning System in accordance with the present invention;

FIG. 2 illustrates a block diagram of a direct sequence-based spread spectrum system;

FIG. 3 illustrates a receiver portion of a system in accordance with the present invention;

FIG. 4 illustrates a typical stepping of the frequency as performed in the related art;

FIG. 5 illustrates another search strategy of the related art;

FIG. 6 illustrates a search strategy of the present invention;

FIG. 7 illustrates another search strategy in accordance with the present invention; and

FIG. 8 illustrates a flowchart illustrating the steps used to perform the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

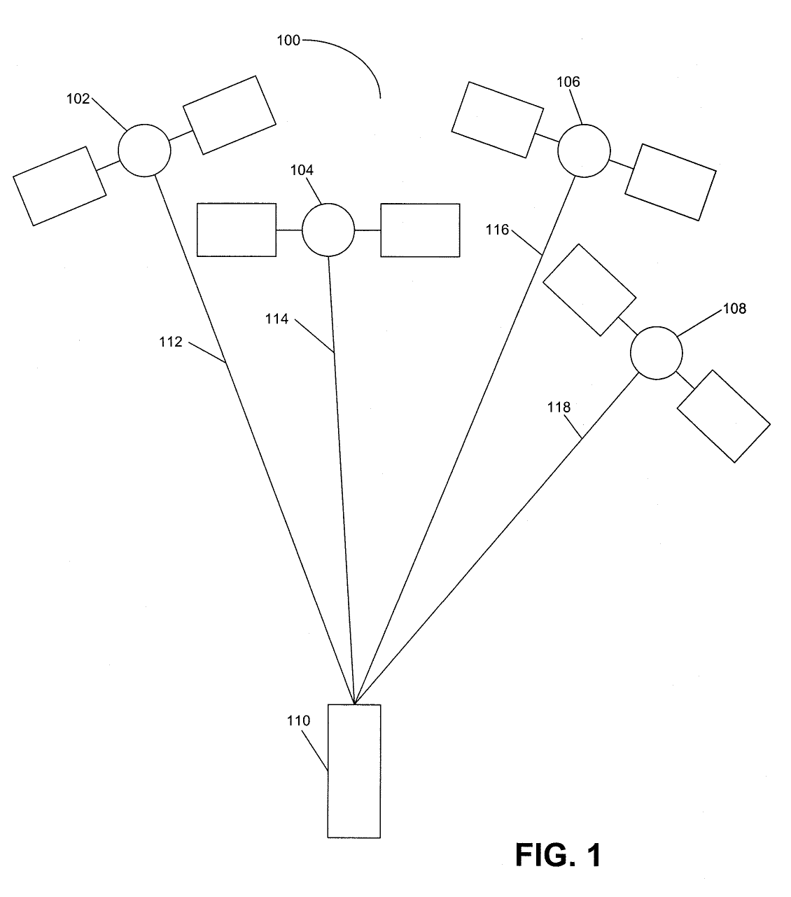

FIG. 1 illustrates a typical Satellite Positioning System in accordance with the present invention.

System 100 illustrates a constellation of satellites 102-108 and a receiver 110. Each of the satellites 102-108 transmits a signal 112-118 respectively, which signals 112-118 are received by receiver 110.

Signals 112-118 contain information such as time of transmission and system time for system 100. Receiver 110 uses the time it takes for signals 112-118 to travel the distances between the satellites 102-108 and receiver 110 and the data within signals 112-118 to determine the x, y, and z coordinates (geoposition) of receiver 110. This generic ranging system is typically known as the Global Positioning System (GPS), which is described in the related art.

The frequencies of interest in a GPS system 100 are in the “L-band” of frequencies, typically around 1575 MHz, but other positioning systems with other frequencies of interest can also benefit from the present invention.

Transmitter Portion

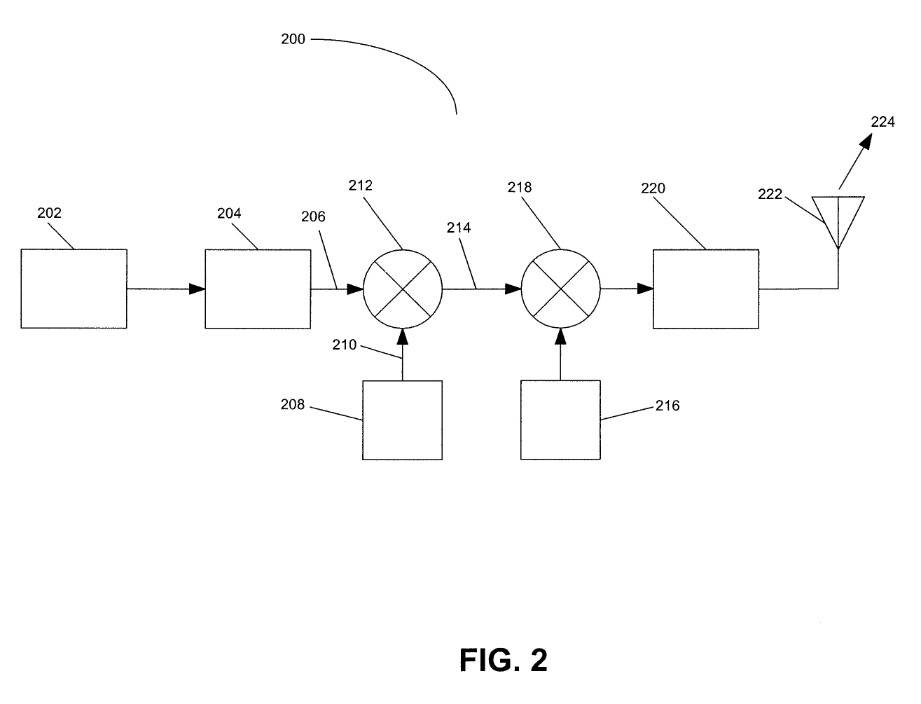

FIG. 2 illustrates a block diagram of a direct sequence-based spread spectrum system. In transmitter 200, a signal from a data source 202 is first modulated in a data modulator 204 of transmitter 200 and generates signal 206. A spreading code generator 208 generates a complex spreading code 210 which is mixed with signal 206 to generate a spread signal 214 by mixing the signal 206 with the spreading code 210. This mixing operation at mixer 212 “spreads” the signal 206 across a frequency spectrum of predetermined frequencies.

Spread signal 214 is then mixed with the output of a Radio Frequency (RF) oscillator 216 at mixer 218, and then amplified by amplifier 220 before being transmitted by antenna 222. Transmitted signal 224 is then transmitted, and transmitted signal 224 (signals 112-118 of FIG. 1) is a spread spectrum signal that is modulated around the RF oscillator 216 frequency.

Receiver Portion

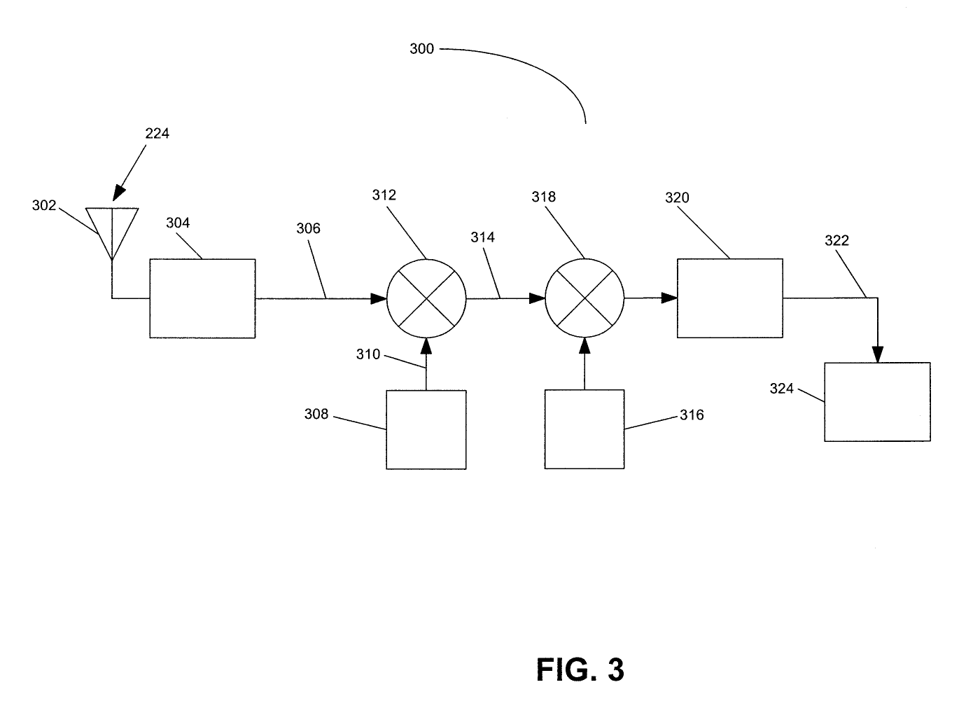

FIG. 3 illustrates a receiver portion of a system in accordance with the present invention.

The transmitted signal 224 is received at antenna 302 and filtered through a RF filter 304 to find signal 224 out of the entire frequency spectrum that is received by antenna 302. This filtered signal 306 is then mixed with a Voltage Controlled Oscillator (VCO) 308 output 310 to downconvert the filtered signal 306 to a lower frequency signal 314 for processing.

An output from a spread spectrum code generator 316 is then mixed with signal 314 at mixer 318, and filtered at bandpass filter 320, to “despread” the signal 224 into signal 322. The signal 314 is a replica of the spreading code generated by code generator 208, and, when the signal 314 and signal 210 are identical and in-phase with each other, the signals correlate and the transmitted data modulation present on signal 224 can be restored prior to the mixing of signal 210 and signal 206. However, if the signal 314 and signal 210 are either out of phase or not identical, the signals do not correlate, and the transmitted data modulation will not be properly restored. Regardless of the correlation between signal 314 and signal 210, other spurious signals are also despread, and bandpass filter 320 removes those spurious signals from being processed by the data detection circuitry. The bandpass filter 320 allows the data modulation to pass through to the data detection circuitry. Signal 322 is then sent to a data detector (correlator) 324 to locate the data present in signal 224.

In order to enable the detection of transmitted data 224 in a spread spectrum receiver 300, the code replica generated by the code generator 316 in receiver 300 has to be synchronized with the received code as accurately as possible to perform an “acquisition” of a signal, and said synchronization has to be maintained for receiver 300 to “track” signal 224. The spreading code replica generated in the code generator 316 thus has to be at the proper frequency, be in phase with, and stay in phase with the spreading code included in the received signal 224. For this reason, a special synchronization algorithm or unit is required for code synchronization, in addition to regular carrier and data synchronization. The speed of the acquisition, i.e. the time taken by the code replica to hit the right frequency and phase with the received code 224, is an important performance parameter of a spread spectrum system. Many methods have been developed for the acquisition, in addition to which the system may comprise different aids for the acquisition that are related to the transmitted signal.

Typically, the code generator 316 is stepped in time, e.g., by delaying and or advancing the beginning of the despreading code generated by the code generator, to alter the phase, and the frequency range is chosen based on the expected receive frequency (determined by RF oscillator 216 and VCO 308, which frequencies are known by receiver 300) to look in different “frequency bins” to find the signal 224, i.e., to match the code generator phase and frequency to that of the signal 224 during comparison in the correlator 324. Although shown as a single correlator 324, multiple correlators 324 are represented by the correlator 324 shown in FIG. 3.

Typically, the receiver 300 has two sections, an RF section 326 and a baseband section 328. At times, the RF section 326 is on a first integrated circuit chip and the baseband section 328 is on a different integrated circuit chip, but the RF section 326 and the baseband section 328 can be located on a single integrated circuit chip if desired.

Search Strategy

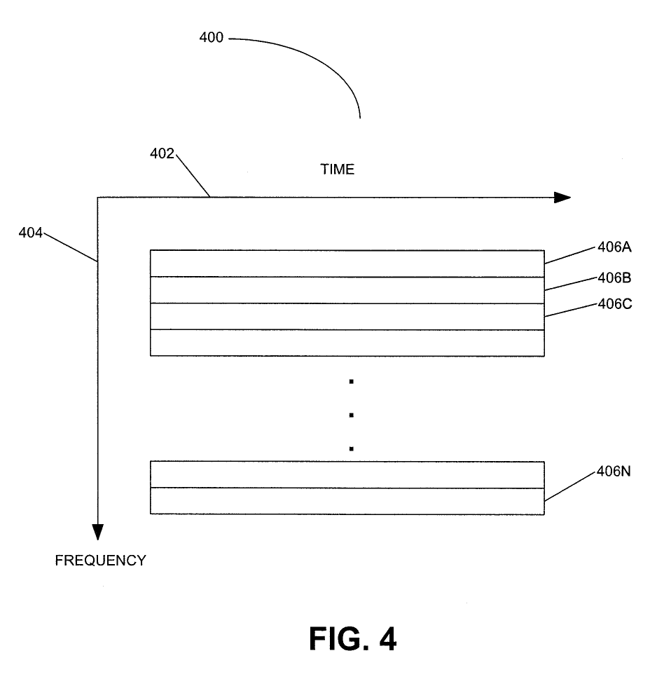

FIG. 4 illustrates a typical stepping of the frequency as performed in the related art.

Chart 400 illustrates a time axis (code phase axis) 402 and a frequency axis 404. Within chart 400, a receiver 300 correlator 324 searches through time and frequency “bins” 406A-406N by comparing a known sequence generated by generator 316 to signals 224 (signals 112-118).

As receiver 300 searches through a specific bin, e.g., bin 406A, receiver 300 starts with typically the lowest frequency and the lowest phase that a given signal 224 can be located in, and the upper edge of the bin 406A is chosen such that the entire signal 224, or a portion of signal 224, will fit within the bin 406A. So, typically, once the correlation between signal 316 and signal 224 is determined by correlator 324 (based on the characteristics of signal 322), the receiver 300 determines whether or not the phase of code generator 316 is correct. If not, the next bin 406B is chosen, and the phase of code generator 316 is changed, and another determination is made. This comparison continues until a threshold value of comparison is reached, which means that the phase of code generator 316 is approximately that of generator 208, and tracking of the signal 224 by receiver 300 can begin.

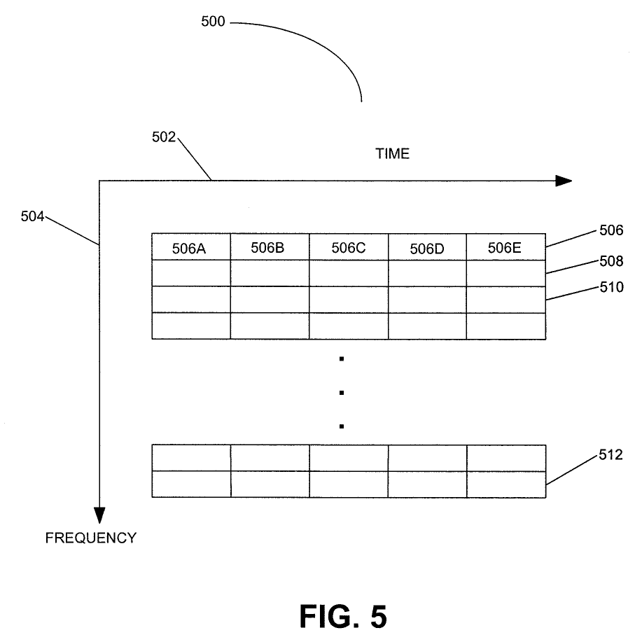

FIG. 5 illustrates another search strategy of the related art.

Chart 500 illustrates a time axis (code phase axis) 502 and a frequency axis 504. Within chart 500, a receiver 300 searches through time and frequency “bins” 506-512 by comparing a known sequence generated by generator 316 to signals 224 (signals 112-118).

However, now each frequency bin 506-512 is broken down into smaller code phase (range) segments, such that multiple correlators can look at a given signal at the same time. So, for example, as receiver 300 searches through specific bins, e.g., bins 506A through 506E, receiver 300 can look through each of the smaller code phase bins 506A-506E in parallel by using multiple correlators 324 and determine with greater speed where signal 224 is, i.e., what phase delay or advance must be applied to code generator 316 to “find” signal 224.

This parallel search can then be used again if the signal is not located in row 506, by applying the parallel correlators 324 to bin 508, bin 512, etc. until all of the possible frequency and phase locations have been searched or the signal 224 is located.

The approach of FIG. 5 speeds up the initial acquisition by being able to search through the same amount of signal space in a 1/m fashion, where m is the number of correlators. As such, the system of FIG. 5 is m times faster in initial acquisition.

However, after the signal 224 is lost for some reason, e.g., receiver 300 enters a tunnel or is otherwise blocked from seeing signal 224 or other signals 112-118, the receiver 300 typically starts all over again with a new acquisition, and the signals from all of the satellites 102-108 must be found again. In some systems, the receiver 300 is programmed to jump right to the frequency bin 406A-406N, or to the frequency slot 506-512, where the signal 224 was located just prior to the loss of signal 224. However, since typical receivers 300 track several signals 224 simultaneously, the receiver 300 must do this reacquisition sequentially; first find signal 112 from satellite 102, then find signal 114 from satellite 104, etc.

The present invention allows for receivers 300 to reconfigure the searching capabilities of the receiver 300 of the present invention to reacquire signals 112-118 (collectively called signals 224) simultaneously by allowing each of the frequency bins to be searched regardless of the bin's location within the time-frequency graph.

Even in situations where two search engines in a given receiver 300 need to be chained together in order to conduct a search (often called a “dual-dwell” search) typically due to larger code phase uncertainty, the reconfigurable nature of the present invention allows a smaller search engine to perform the second dwell (also known as the “verification round”) regardless of how many engines were used during the first dwell. This approach which is enabled by the present invention allows the remainder of the search engine to be shut down to save power, or used to find other signals to allow for faster acquisition speeds.

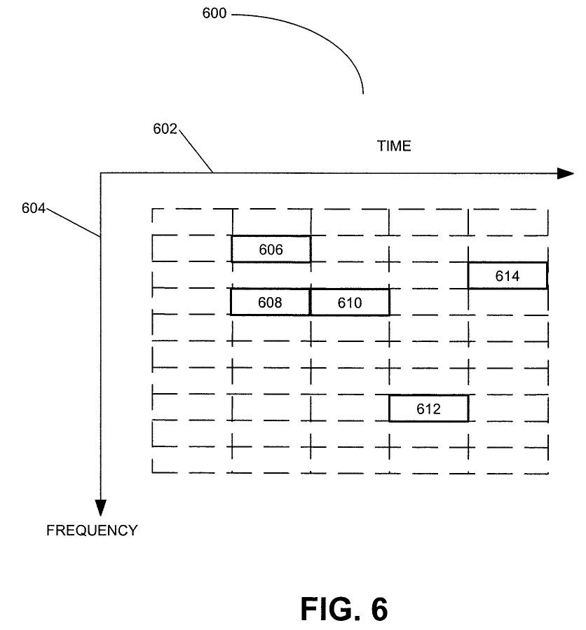

FIG. 6 illustrates a search strategy of the present invention.

Chart 600 illustrates a time axis (code phase axis) 602 and a frequency axis 604. Within chart 600, a receiver 300 searches through time and frequency “bins” by assigning correlators to specific frequency bins, e.g., frequency bins 606-614, such that each correlator can review the signals 112-118 that are present in the frequency bins 606-614. Unlike the related art, where each of the correlators had to look in a given “slice” of frequency and/or time, each of the correlators of the present invention looks in a bin based on the knowledge that receiver 300 has of where the signals 112-118 (signals 224) were prior to loss of tracking of those signals 112-118, and therefore, can look in those specific places simultaneously. Further, since the receiver 300 knows how long it has been since receiver 300 lost the tracking lock of the signals 112-118, the receiver 300 has a priori knowledge of how far the signal 112-118 can move in both frequency and time (code phase delay) and therefore knows how large of a frequency bin to look in to reacquire the signal 112-118.

In the related art, if five satellites 102-108 are being tracked, it will take at least five sample times to go through and find all five of those satellites 102-108, because the prior search engines look for one satellite 102-108 at a time. The present invention uses the knowledge to reduce the time and frequency bin size, and looks at each of the frequency bins where the receiver 300 previously found the signals 112-118 (signals 224) and assigns correlators to those specific frequency bins.

The present invention also allows for reducing the frequency and time “sizes” of the bins 606-614, such that the correlator is searching over a smaller segment of frequency and/or time based on the a priori knowledge of the signals 224. As such, the receiver 300 can reacquire the satellite signals 112-118 faster by an order of M, where M is the number of correlators 324 in the receiver 300.

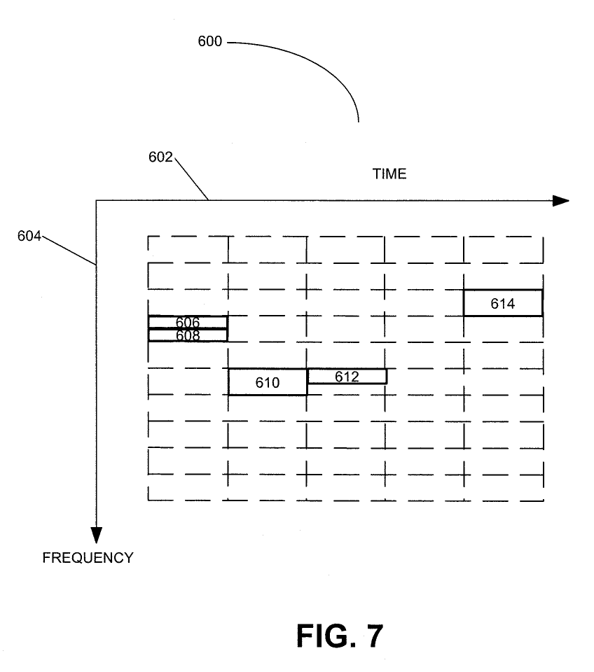

FIG. 7 illustrates another search strategy in accordance with the present invention.

FIG. 7 shows that some of the bins 606-614 can be reduced in terms of frequency as well as time, e.g., bins 606, 608, and 612, which also use a priori knowledge of the location of the signals 112-118 to search over a smaller frequency range. So, for example, rather than search over an entire frequency bin range, say 2 kilohertz, the bin can search over a fraction of that, e.g., 1 kilohertz, 500 hertz, etc. to more quickly locate the lost signal 112-118. If the exact location of the signal 112-118 is not known with enough accuracy, other bins, e.g., bins 610-614, are searched using the entire frequency range to ensure reacquisition of the signal 112-118.

As such, each correlator 324 is given a specific frequency bin, as well as a specific frequency range (shown in FIG. 7) and a code phase delay (the code phase axis shown in FIGS. 6 and 7) to search for a given satellite signal 112-118. Since the knowledge of where the signal 112-118 was prior to loss of tracking of the signal 112-118 is used to start the search, the number of frequency bins that need to be searched, and the amount of those frequency bins that need to be searched, are reduced. This reduction in search area translates into faster reacquisition times for receiver 300.

Process Chart

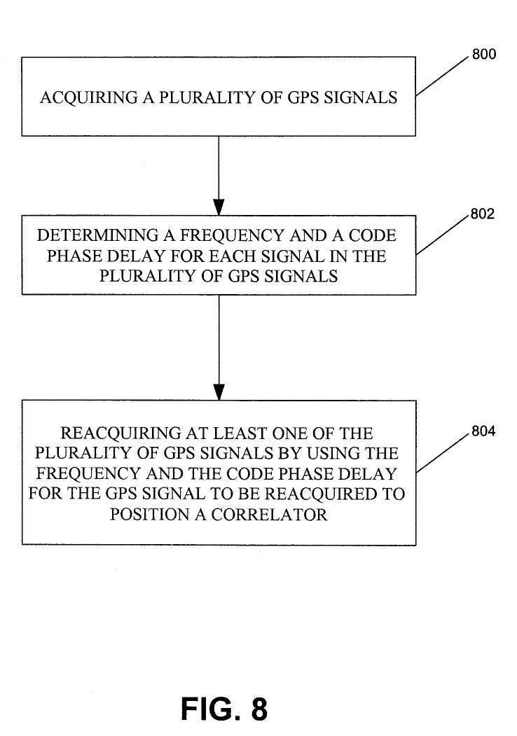

FIG. 8 illustrates a flowchart illustrating the steps used to perform the present invention.

Block 800 illustrates acquiring a plurality of GPS signals.

Block 802 illustrates determining a frequency and a code phase delay for each signal in the plurality of GPS signals.

Block 804 illustrates reacquiring at least one of the plurality of GPS signals by using the frequency and the code phase delay for the GPS signal to be reacquired to position a correlator.

### CONCLUSION

In summary, the present invention describes a method and apparatus for reconfiguring a GPS receiver. A device in accordance with the present invention comprises a Radio Frequency (RF) section, the RF section adaptable to receive at least one GPS signal from at least one GPS satellite; and a baseband section, coupled to the RF section, the baseband section comprising at least one correlator, wherein the at least one correlator is adaptable to reacaquire the at least one GPS signal based on a priori knowledge of the at least one GPS signal.

Such a GPS receiver further optionally includes the a priori knowledge of the at least one GPS signal comprising the code phase of the at least one GPS signal, a frequency of the at least one GPS signal, and an amount of time since the GPS receiver lost tracking lock on the at least one GPS signal.

A method in accordance with the present invention comprises acquiring a plurality of GPS signals, determining a frequency and a code phase delay for each signal in the plurality of GPS signals, and reacquiring at least one of the plurality of GPS signals by using the frequency and the code phase delay for the GPS signal to be reacquired to position a correlator.

Such a method further optionally includes the GPS receiver having a priori knowledge of the GPS signal to be reacquired, and the a priori knowledge comprises an amount of time since the GPS receiver lost tracking lock on the GPS signal to be reacquired.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but by the claims and the equivalents of the claims which form a part of this application.

What is claimed is:

1. A Global Positioning System (GPS) receiver, comprising:
a Radio Frequency (RF) section, the RF section adaptable to receive at least one GPS signal from at least one GPS satellite; and
a baseband section, coupled to the RF section, the baseband section comprising at least one correlator, wherein the at least one correlator is adaptable to reacaquire the at least one GPS signal based on a priori knowledge of the at least one GPS signal.

2. The GPS receiver of claim 1, wherein the a priori knowledge of the at least one GPS signal comprises the code phase of the at least one GPS signal.

3. The GPS receiver of claim 2, wherein the a priori knowledge of the at least one GPS signal further comprises a frequency of the at least one GPS signal.

4. The GPS receiver of claim 3, wherein the a priori knowledge of the at least one GPS signal further comprises an amount of time since the GPS receiver lost tracking lock on the at least one GPS signal.

5. A method for reconfiguring a Global Positioning System (GPS) receiver, comprising:
acquiring a plurality of GPS signals;
determining a frequency and a code phase delay for each signal in the plurality of GPS signals; and
reacquiring at least one of the plurality of GPS signals by using the frequency and the code phase delay for the GPS signal to be reacquired to position a correlator.

6. The method of claim 5, wherein the GPS receiver has a priori knowledge of the GPS signal to be reacquired, and the a priori knowledge comprises an amount of time since the GPS receiver lost tracking lock on the GPS signal to be reacquired.
